(19) United States
(12) Patent Application Publication
(10) Pub. No.: US 2015/0199638 A1
(43) Pub. Date: Jul. 16, 2015

(54) PERFORMANCE METRICS TREND ANALYSIS OF FEATURES PRESENT IN TRANSPORTATION SYSTEMS

(71) Applicant: Xerox Corporation, Norwalk, CT (US)

(72) Inventor: Alvaro E. Gil, Rochester, NY (US)

(73) Assignee: Xerox Corporation, Norwalk, CT (US)

(21) Appl. No.: 14/153,312

(22) Filed: Jan. 13, 2014

(51) Int. Cl. G06Q 10/06; G06Q 50/30

(52) U.S. Cl. CPC G06Q 10/06395; G06Q 50/30

(57) ABSTRACT

A system for analyzing transportation service performance receives a first parameter of interest for the service and identifies an historic trending change in the parameter of interest. The system then accesses a data set of a set of additional performance parameters to determine which of the additional parameters most influenced the change in the first parameter. The system may do this by identifying trending changes for each of the additional parameters and automatically determining which of the additional parameters influenced the change in the parameter of interest.

### BACKGROUND

Transit agencies and other transportation service providers frequently face the problem of having a massive amount of performance data that awaits analysis in order to determine what features of the system are performing well and what features of the system are performing poorly. It is very expensive to use human experts to perform this analysis. Further, when this is carried out by humans, the results may be too late to act upon, since the opportunities to implement changes at the right time may no longer be available by the time the human analyzes the data.

Often when transit agencies find a feature that is performing poorly (or well), it is difficult for them to determine what factor or factors are causing the performance. Thus, transportation service providers can benefit from improved ways to help identify performance metrics.

### SUMMARY

In an embodiment, a system for analyzing transportation service performance includes a data storage facility containing historic values for a plurality of performance parameters of a plurality of transportation service route components, a processor (which may be one processor or a group of processors) and a computer-readable medium containing programming instructions that, when executed, cause the processor to implement a method of analyzing transportation service performance. When executed, the instructions cause the system to: receive a selection of a route component, a time scale, and a parameter of interest; identify a trending change in the parameter of interest during the time scale; retrieve, from the data storage facility, values for a plurality of additional performance parameters that correspond to the selected route component and the selected time scale; and analyze the retrieved values for the plurality of additional performance parameters to identify trending changes in each of the additional performance parameters. Based on the identified trending changes in the additional performance parameters, the system will determine which of the additional performance parameters influenced the trending change of the parameter of interest. The system will also output an identification of, and a graphic depiction of values during the time scale for, one or more of the additional performance parameters that influenced the trending change of the parameter of interest.

Optionally, when identifying a trending change in the parameter of interest the system may identify a change in a behavioral pattern such as linear behavior, non-linear behavior, or oscillating behavior. When determining which of the additional performance parameters influenced the trending change of the parameter of interest, the system may only consider those additional performance parameters whose trending changes exhibit the behavioral pattern. In other words, the system may not consider additional performance parameters whose changes do not exhibit the behavioral pattern.

Optionally, the system may receive a selection of a sampling frequency. If so, then when retrieving the values for the plurality of additional performance parameters from the data storage facility, the system may yield a set of values that correspond to the sampling frequency.

Optionally, when analyzing the retrieved values that correspond to the additional performance parameters to identify trending changes in each of the additional performance parameters, the system may, for each of the additional performance parameters: determine a plurality of magnitudes of the values of the additional performance parameter over the time scale. For each determined magnitude, the system may determine a coefficient. For each coefficient, the system may determine whether the coefficient has a positive or negative value. Based on the determined positive or negative value, the system may assign a behavioral pattern to the additional performance parameter over the time scale. Optionally, the system may use one or more of the following algorithms to estimate the coefficient: Levenberg-Marquardt, Steepest Descent, Conjugate Gradient, Genetic Algorithms, or Nelder-Mead.

In some embodiments, the system may receive a break point. Then, when analyzing the trending changes for each of the additional performance parameters, the system may determine whether there is a change in a behavioral pattern of the trending change within a threshold distance from the break point. If so, then when determining which of the additional performance parameters influenced the trending change of the parameter of interest, the system may identify additional parameters that exhibit the same change in the behavioral pattern within the threshold distance from the break point.

In another embodiment, a system for analyzing transportation service performance includes a data storage facility containing historic values for performance parameters of various transportation service route components, a processor (which may be one processor or a group of processors) and a computer-readable medium containing programming instructions that, when executed, cause the processor to implement a method of analyzing transportation service performance. When executed, the instructions cause the system to: receive a selection of a route component, a time scale, and a parameter of interest; and identify a change in behavioral pattern of the parameter of interest during the time scale. The change in behavioral pattern may include a change from one of the following behavioral patterns to another of the following behavioral patterns: linear behavior, non-linear behavior, oscillating behavior, or non-oscillating behavior. The system may retrieve, from the data storage facility, values for additional performance parameters that correspond to the selected route component and the selected time scale. The system may then analyze the retrieved values for the additional performance parameters to identify any changes in behavioral patterns of each of the additional performance parameters. Based on the identified changes in behavioral patterns of the additional performance parameters, the system may determine which of the additional performance parameters influenced the trending change of the parameter of interest by identifying those additional performance parameters whose behavioral pattern changes corresponded to the change in behavioral pattern of the parameter of interest. The system may then output an identification of one or more of the additional performance parameters that influenced the change in behavioral pattern of the parameter of interest.

Optionally, the system also may include instructions that, when executed, cause the processor to: receive a selection of a sampling frequency, and when retrieving the values for the plurality of additional performance parameters from the data storage facility, yield a set of values that correspond to the sampling frequency.

Optionally, the instructions to analyze the retrieved values that correspond to the additional performance parameters to identify changes in behavioral patterns of each of the additional performance parameters may include instructions to, for each of the additional performance parameters: determine magnitudes of the values of the additional performance parameter over the time scale; for each determined magnitude, determine a coefficient; for each coefficient, determine whether the coefficient has a positive or negative value; and based on the determined positive or negative value, assign a behavioral pattern to the additional performance parameter over the time scale.

Optionally, the instructions may also include instructions to receive a break point. Then, when identifying the change in the behavioral pattern of the parameter of interest, the system may determine whether there is a change in a behavioral pattern of the parameter of interest within a threshold distance from the break point. When determining which of the additional performance parameters influenced the change in behavioral pattern of the parameter of interest, the system may identify additional parameters that exhibit a corresponding change in behavioral pattern within the threshold distance from the break point.

### BRIEF DESCRIPTION OF THE DRAWINGS

FIG. 1 is a flow diagram illustrating a method of trend analysis.

FIG. 2 is a plot showing an example of a historical trend for travel time on a group of bus routes.

FIG. 3 is a plot showing an example of a historical trend for ridership on the group of bus routes.

FIG. 4 is a plot showing an example of a historical trend for travel time reliability of the group of bus routes.

FIG. 5 is a block diagram showing elements of computing systems that may be used to implement various embodiments described in this document.

### DETAILED DESCRIPTION

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to.”

As used in this document, the terms “transportation service” and “transit service,” as well as transportation or transit systems, interchangeably refer to an entity that owns, operates or manages a fleet of vehicles that travel various routes according to determined schedules. Examples of transit services include public bus services, rail transit systems, airlines, air traffic control agencies, and similar systems.

This document refers to a “route component” as a scheduled operational component of one or more routes of a transit service. Examples of route components include stops (such as bus or train stops), segments of routes (such as a first leg of an airplane's itinerary, or a sequence of scheduled bus stops along a bus route), a particular vehicle (e.g., bus, plane or train) or a specific human vehicle operator (e.g., driver or pilot), or a complete route including all stops from a first point A to a second point B.

When this document uses the term “operational data” with respect to a route component, it refers to one or more measurable parameters of the route component. This document may use the terms parameters and features interchangeably when discussing measurable parameters of route components. Examples of categories of operational data include ridership data for a route (such as a number of passengers who travel the route), a capacity usage measurement (such as the percent of the capacity of a particular vehicle is being used), a measure of the number of riders waiting at a particular stop, revenue per distance element (such as dollars per mile), amount of delay, vehicle or driver performance criteria (such as whether the vehicle/driver follows speed, acceleration or deceleration requirements), headway regularity (i.e., the time between vehicles at a particular stop) and other metrics.

This disclosure is directed to a method and system for analyzing data from a transit system in a way that can help the system operator determine what routes or route components are performing poorly, which ones are performing well, and what parameters are contributing to the performance. For example, public transportation companies monitor quality of service analytics related to how a transit system is performing. Generally, the analytics reflect average performance of the transit system, variation of the performance over time, and a general distribution of performance over time. For a public transportation system, low quality of service can result in decreased ridership, higher costs and imbalanced passenger loads. As performance variability increases, waiting times also increase, thereby directly impacting customer satisfaction. From a passenger perspective, reliable service requires origination and destination points that are easily accessible, predictable arrival times at a transit stop, short running times on a transit vehicle, and low variability of running time. Poor quality of service can arise from inefficiencies inherent in the system, and it can prompt passengers to choose another transportation option, thereby reducing the public transportation service provider's income.

This document describes new methods and systems for analyzing historical transportation system trends to identify and group transportation routes that are performing well, routes that do not experience any changes, routes that are performing poorly, and/or other groups in a transportation system.

Transit system managers receive a wide variety of performance metrics whose values can be used to assess how the agencies are doing at different levels (system, route, segment, stop, etc.). These metrics can also be used to design changes in the transit infrastructure so that an unsatisfactory performance can be turned into a satisfactory one. Any number of metrics—extending into the hundreds or higher—may be collected. For example, in public bus systems, it is common for the service provider to track about 20 metrics per route. In a system that includes dozens of routes, 20+ metrics per route, and historical data over a period of several months, the volume information to be analyzed by a service provider can quickly become overwhelming. Therefore, there is a need to have a way to distill this data into easily readable formats, including formats that show trending changes in performance and the factors that are the primary contributors to the change.

This document describes a method that a transportation service monitoring system may use to help system planners identify trending changes, as well as the parameters that are the primary influences on those changes. The method does this through an automatic analysis that groups route components that, with respect to a parameter of interest, are performing well and trending in an improving way, not experiencing any significant changes, have parameters that are oscillating, or are performing poorly and trending in an negative way.

The system includes or has access to a data storage facility that contains historic performance parameters of a transit system. The performance parameters may reflect many elements of operational data for multiple route components of the transit system. Each data element may be a parameter value that is associated with a time at which the data was collected, a route component for which the data element relates, and a category indicating the type of operational data that is represented by the value.

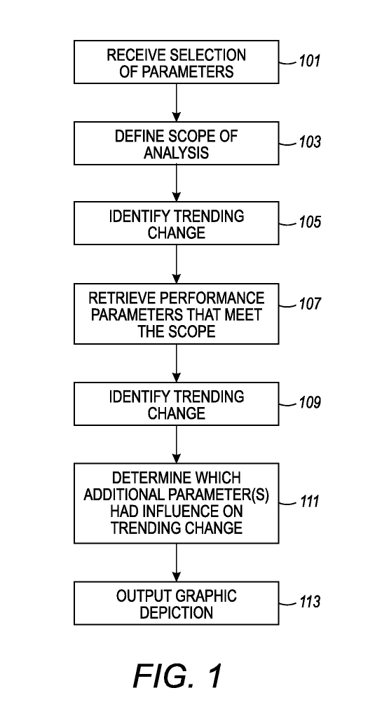

FIG. 1 is a flow diagram describing how the system may implement its analysis. The system will generate and present a user interface containing input fields via which a user can input or otherwise select various parameters (step 101). The system will use those parameters to define the scope of a trend analysis (step 103). For example, the system may receive a user's selection of a route component (route, route segment, vehicle, stop, etc.), a parameter of interest (e.g., on-time performance), a time scale (start and/or end time for the analysis), a break point (i.e., a time within the time scale that the system may use as a reference to compare data before and after the break point), and/or a sampling frequency. This information may be received by free-form text in user interface fields for each category, by drop-down or other menus in the user interface, or by any other input mechanism. Alternatively, the system may receive any or all of this information by an external communication or command, such as a request from an external system.

The system will then identify a trending change in the parameter of interest (step 105). The system may do this by receiving a behavioral pattern via the user interface or from the external system. The behavioral pattern may be a descriptor of a trending change (such as trending upward, trending downward, or oscillating). Alternatively, the system may identify the trending change by retrieving values for the parameter of interest during the time scale, and it may analyze the retrieved values to automatically determine what type of trending change is exhibited by the parameter of interest. (Example analysis methods are described below.) When selecting the parameter values, the system will select those values that relate to the selected route component, within the identified time scale. If a sampling frequency is selected, the system also may filter the retrieved values (or only retrieve values in the first place) so that the values used in the analysis correspond to the sampling frequency.

After defining the scope of the trend analysis, the system will then access the data storage facility and retrieve values for a group of additional performance parameters that correspond to the scope of the selected route component and the selected time scale (step 107). For purpose of the discussion, we will identify the additional parameters as “features” to help distinguish the additional parameters from the parameter of interest. As with the data for the parameter of interest, if a sampling frequency is received, the system may filter the data or select the data for each additional feature so that it uses one data point for each feature during each interval of the frequency, or it may take an average or mean of all available values during each sampling period.

The system will automatically analyze the retrieved values for the additional features to identify whether there is any trending change in values for each additional feature during the time scale (step 109). As noted above, a trending change may be one that trends upward over the selected time scale, one that trends downward over the time scale, or one that oscillates during the time scale. For each additional feature that exhibits a trending change, the system will determine which additional feature or features had an influence on (or that most influenced) the trending change of the parameter of interest (step 111). As described below, the system may do this by determining which additional feature's trending change(s) most closely fit with that of the parameter of interest. The system will then output a graphic depiction of the retrieved values for the parameter of interest, along with an identification of the additional feature(s) that had an influence on the trending change, and optionally the retrieved values for the additional feature (step 113).

To analyze the data and determine whether a trending change exists in any parameter values, the system may implement any suitable methods of calculation and analysis. By way of example, potential trends that may be identified in the trend analysis are metrics that increase/decrease linearly, increase/decrease nonlinearly, oscillate, and/or abruptly change. The system also may search for other types of trends. The system also may identify cases where there is more than one feature in the trend analysis.

Optionally, when analyzing the trending changes, to determine which additional feature's trending change most closely fits with that of the parameter of interest, the system may identify the behavioral pattern of the pattern of interest (e.g., upward, downward, oscillating, etc.) and only look for or compare trending changes for additional features that also exhibit the same behavioral pattern.

As a method of automated trend analysis that the system may employ, let y(t) denote a performance metric of the historical trend to be analyzed. Let t={tᵢ, . . . , t_{b}, . . . , t_{ƒ}} denote a time scale where tᵢ is the initial time of the trend, t_{b} is the breaking point, and t_{ƒ}is the final time of the trend. The system may identify a magnitude of each feature by a function y(t) according to the equation:

$$y ( t ) = {α}_{0} + {\sum }_{i = 1}^{N} {α}_{i} * {f}_{i} ( t )$$

where α₀ is the offset coefficient of y(t), ƒᵢ(t) is the i^{th} feature of interest, αᵢ is the coefficient of ƒᵢ(t), and N is the number of features that the system will analyze in the historical trend.

Examples of measurements that the system may determine for each feature ƒᵢ(t) are: (1) ƒᵢ(t)=t to detect whether measured values of the feature are increasing/decreasing linearly during the time scale (αᵢ positive/negative); (2) ƒᵢ(t)=t² to detect whether the values of the feature are increasing/decreasing nonlinearly (αᵢ positive/negative); (3) ƒᵢ(t)=cos(wᵢt) or ƒᵢ(t)=sin(wᵢt) to detect whether the values of the feature are oscillating with frequency wᵢ; and (4) ƒᵢ(t)=8 (t) to detect whether there is an abrupt increase/decrease in the values of the feature (αᵢ positive/negative, δ(t) being the impulse function).

In this case, the system knows the values of y(t) and ƒᵢ(t) from the historical data. It may estimate the coefficients α₀, αᵢ, and wᵢ (if the system attempts to detect feature oscillation) using the Levenberg-Marquardt (LM) algorithm to derive both the coefficients and wᵢ, although other methods may be used to determine the coefficients. In addition to the LM algorithm, other suitable algorithms include the Steepest Descent, Conjugate Gradient, Genetic Algorithms, and Nelder-Mead algorithms.

To determine the coefficients αᵢ, the system may use an algorithm such as:

θ(j+1)=θ(j)−(∇ε∇ε^{T}+λI)⁻¹∇εε

in which j+1 represents a next iteration of the algorithm after the jth iteration that updates the parameter θ(j+1). The number of iterations of the algorithm may be predetermined, or the iterations may continue until a desired criterion is satisfied, such as if the error ε (defined below) is less than or equal to a desired value. If there are N features to consider during the evaluation and M data points in the historical trend, then the vector:

θ(j)=[α₀(j)α₁(j) . . . α_{N}(j)]_{(N+1)×1}

represents the coefficient values at iteration j, λ is a constant value, I_{(N+1)×(N+1)} is the identity matrix, ε=y(t)−ŷ(t) is the error between the metric and the estimated metric, ∇ε_{(N+1)×M} is the gradient of ε_{N×M}, and A^{T} denotes the transpose of the matrix A. (For the purpose of this example, wᵢ is not included as part of θ(j) for simplicity).

Notice that if a break point t_{b} is specified, then the system may apply the algorithm for the time series [tᵢ, . . . , t_{b}] and for [t_{b}, . . . , t_{ƒ}] independently, and the system may then compare the results to each other. As another option, the system may run the algorithm for the time [tᵢ, . . . , t_{ƒ}] and monitor the result to identify whether there is any change in a behavioral pattern of the trending change at or substantially near (within a threshold distance—i.e., period of time—from) time t_{b}. The system may apply this algorithm in multiple instances in parallel to analyze different trends at the same time.

Once the estimated coefficients αᵢ, i=1, . . . , N, are derived (such as by using the LM algorithm), the system may normalize the coefficients

$$( e . g . , {α}_{i}^{l} = \frac{\vert \hat{{α}_{l} \vert}}{{Σ}_{i = 1}^{N} \vert \hat{{α}_{l}} \vert} )$$

and sort them from largest to smallest values. The order will indicate how the historical trend is performing throughout the time and help the system identify which features have the most influence on the trend. The system may monitor the coefficients of both the linear and nonlinear functions when they are included at the same time. For instance, assume that α₁ and α₂ are the coefficients of the linear and nonlinear functions respectively. The system may solve for t in the inequality |α₁|<|α₂|*t since this would show when the nonlinear term starts increasing/decreasing more rapidly than the linear term. For instance, if

$${t}_{i} < \vert \frac{\hat{{α}_{1}}}{\hat{{α}_{2}}} \vert < t < {t}_{f}$$

and α₁^{t}>α₂^{t}, at tᵢ, then the historical trend may switch from a linear to a nonlinear behavior somewhere in between times tᵢ and t_{ƒ}.

One factor for the inclusion of the function ƒᵢ*(t)=δ(t) is that when this is requested, then the system determines the coefficients αᵢ, i≠i*, for all the functions except ƒᵢ*(t). Once this is done, then the system may include ƒᵢ*(t) and compute the coefficients αᵢ* including the derived coefficients αᵢ. Thus, the coefficients αᵢ* can be computed by the error y(t)−ŷ(t). This may help the system avoid αᵢ* dominating the fitting and falsely reporting that there are always abrupt changes in the trend.

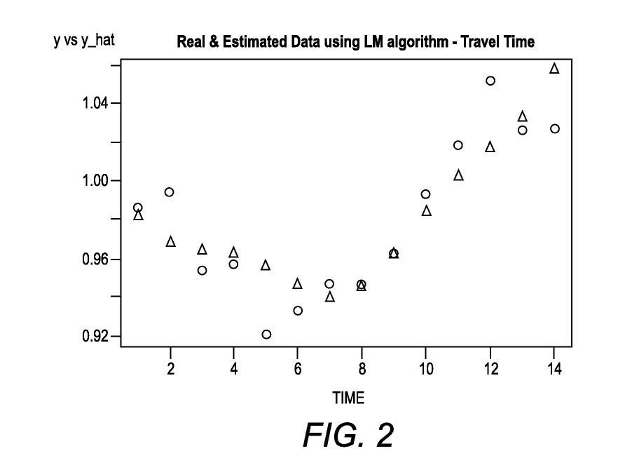

As an example of how the system may implement its analysis, consider a scenario where the system defines a scope of the trend analysis as a group of bus routes. The system will access historical data for the routes and receive a time scale and sampling frequency. (In this example, which will be illustrated in FIGS. 2-4, the time scale will comprehend a 14-month period, the sampling frequency is monthly, and no break point is predetermined.) The system may receive several features of interest from the bus system operator, including ƒ₁(t)=t to detect linear behaviors, ƒ₂ (t)=t² to detect nonlinear behaviors, ƒ₃ (t)=cos (t), and ƒ₄ (t)=sin(t) both to detect oscillatory behaviors. Note that there are multiple options for the nonlinear case and the system assumes that the frequency of the oscillations is not important in this example.

The system retrieves historical operational data for the group of bus routes from a data storage facility. The system may automatically search for the trends in the historical data by defining:

$$y ( t ) = {α}_{0} + {α}_{1} * t + {α}_{2} * {t}^{2} + {α}_{3} * cos ( t ) + {α}_{4} * sin ( t )$$

$$and$$

$$\hat{y} ( t ) = \hat{{α}_{0}} + \hat{{α}_{1}} * t + \hat{{α}_{2}} * {t}^{2} + \hat{{α}_{3}} * cos ( t ) + \hat{{α}_{4}} * sin ( t )$$

$$Thus , \\ ∇ ɛ = [ \begin{matrix}- 1 & - 1 & ⋯ & - 1 \\ - {t}_{1} & - {t}_{2} & ⋯ & - {t}_{14} \\ - {t}_{1}^{2} & - {t}_{2}^{2} & ⋯ & - {t}_{14}^{2} \\ - cos ( {t}_{1} ) & - cos ( {t}_{2} ) & ⋯ & - cos ( {t}_{14} ) \\ - sin ( {t}_{1} ) & - sin ( {t}_{2} ) & ⋯ & - sin ( {t}_{14} )\end{matrix} ]$$

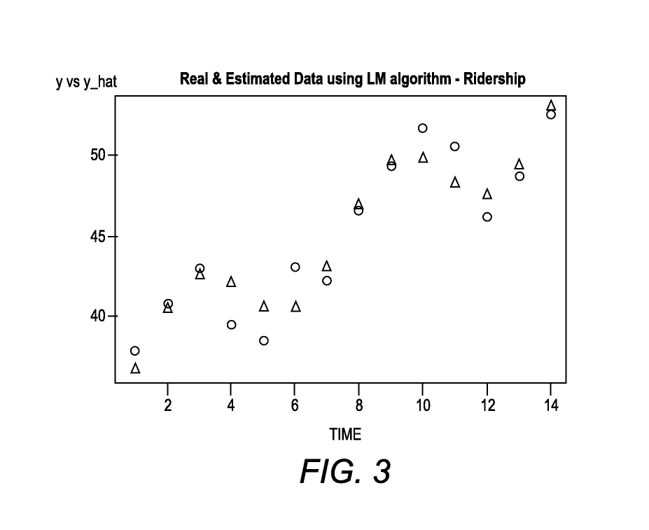

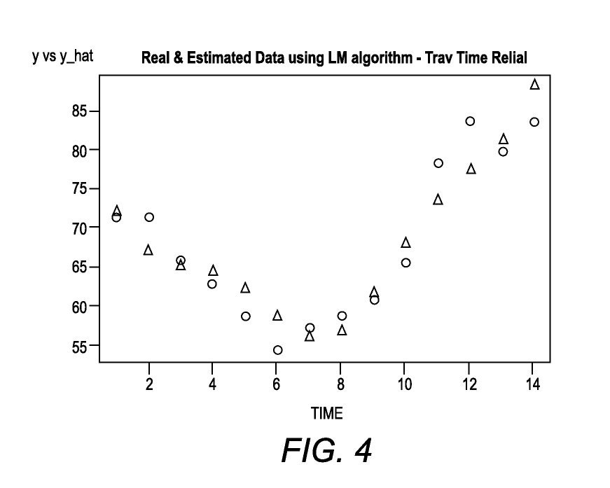

To show how the estimated coefficients can be used for a set of performance metrics, in this example, we chose the route=1 and direction=3 for a particular route component of a transit system. The system applies 40 iterations, initiates \hat{0}(j) using a uniform distribution in the interval [0, 4], and obtains Q=100 trials of \hat{θ}. For each trial kεQ, the system computes the mean squared error MSE(k) and selects the parameters that results in the minimum MSE. FIG. 2 shows a resulting historical trend for the travel time parameter. In this example, the trend is downward until a break point (around month #7), at which time it reverses and trends upward. FIG. 3 shows a resulting historical trend for the ridership parameter, showing an oscillatory linear increase trend. FIG. 4 shows the historical trend for the travel time reliability parameter. Like FIG. 2, FIG. 4 also shows a downward trend followed by an upward trend after a break point. In each of FIGS. 2-4, circles represent actual measured data and triangles represent estimated data. Perfect fitting is not required for this analysis since the system is merely capturing trends and not specific measurements of the features of interest.

To determine which additional parameters have the most influence on the trends, the system will analyze the outcome of the results via a set of rules that will classify any scope into the parameter of interest and/or additional features. As noted above, the system may identify that metrics in FIGS. 2 and 4 decrease linearly and later increase nonlinearly with some minor oscillations. The system will identify that the data of FIG. 3 is primarily oscillatory with a linear increase. To understand how the system may do this automatically (i.e., by calculation without the requirement for visual representation), consider the following normalized coefficients:

The coefficients for FIG. 2 may be

$${α}_{1} = - 0.022 ( {α}_{1}^{l} = 0.61 ) , {α}_{4} = - 0.009 ( {α}_{4}^{l} = 0.25 ) , {α}_{3} = - 0.003 ( {α}_{3}^{l} = 0.08 ) , {α}_{2} = 0.001 ( {α}_{2}^{l} = 0.06 ) , {t}_{i} < \vert \frac{\hat{{α}_{1}}}{\hat{{α}_{2}}} \vert = 11.9 < {t}_{f} .$$

As noted above, α₁ and α₂ are coefficients of the linear and nonlinear functions. Coefficients α₃ and α₄ are coefficients of the sine and cosine functions described earlier in this discussion. The system may calculate these coefficients and note that the values are negative for each function except the non-linear coefficient α₂. The swings between positive and negative values indicate that this fitting is indicating that the metric decreases linearly with some oscillations and that it will switch to an increasing nonlinear behavior at around month #12.

The coefficients for FIG. 3 are

$${α}_{4} = - 2.68 ( {α}_{4}^{l} = 0.56 ) , {α}_{1} = 1.22 ( {α}_{1}^{l} = 0.25 ) , {α}_{3} = 0.88 ( {α}_{3}^{l} = 0.18 ) , {α}_{2} = - 0.004 ( {α}_{2}^{l} = 0.0008 ) , {t}_{i} < \vert \frac{\hat{{α}_{1}}}{\hat{{α}_{2}}} \vert = 296 < {t}_{f} .$$

Thus, the trend has high oscillations with a linear increase and will not have nonlinear behaviors since

$$\vert \frac{\hat{{α}_{1}}}{\hat{{α}_{2}}} \vert$$

is outside the 14-month time scale (as shown by the x axis in the plot).

The coefficients for FIG. 4 are

$${α}_{1} = - 7.37 ( {α}_{1}^{l} = 0.62 ) , {α}_{4} = - 3.15 ( {α}_{4}^{l} = 0.28 ) , {α}_{3} = - 0.73 ( {α}_{3}^{l} = 0.06 ) , {α}_{2} = 0.57 ( {α}_{2}^{l} = 0.04 ) , {t}_{i} < \vert \frac{\hat{{α}_{1}}}{\hat{{α}_{2}}} \vert = 12.8 < {t}_{f} .$$

Thus, the trend exhibits a linearly oscillating decrease and will switch to an increase in nonlinear behaviors since

$$\vert \frac{\hat{{α}_{1}}}{\hat{{α}_{2}}} \vert$$

is within the time range considered in the plot.

Note that all of these estimated behaviors correspond with what is observed in the real data. One common observation is that the time when a switch is estimated from a linear to a nonlinear is very conservative. One reason might be because it may be desired that the system only account for the ratio

$$\vert \frac{\hat{{α}_{1}}}{\hat{{α}_{2}}} \vert$$

ignoring α₃ and α₄. Also, notice that if a break point t_{b} is specified, then the time when a feature switches from one behavior to another behavior (e.g., linear to non-linear, or linear to oscillatory) can be compared to t_{b} to report a before and after behavior around this break point. This may help the system or an operator determine what parameter or parameters influenced the change.

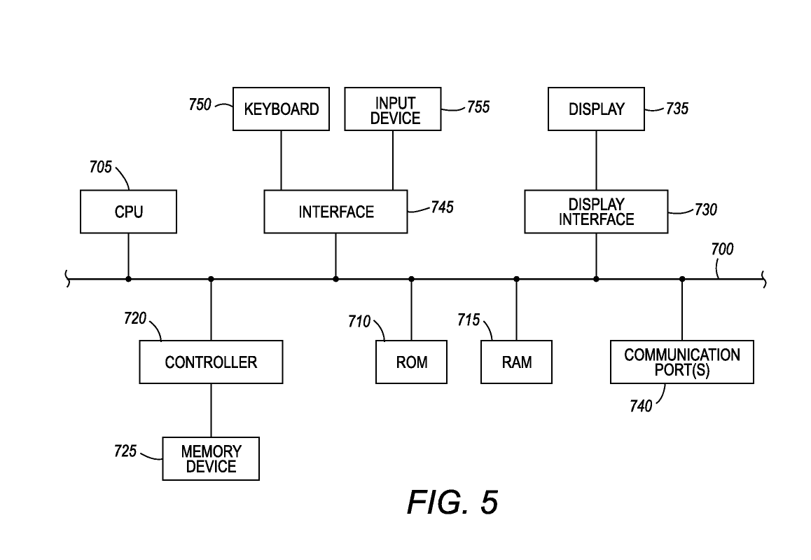

FIG. 5 depicts an example of internal hardware that may be used to contain or implement the various computer processes and systems as discussed above. An electrical bus 700 serves as an information highway interconnecting the other illustrated components of the hardware. CPU 705 is a central processing unit of the system, performing calculations and logic operations required to execute a program. CPU 705, alone or in conjunction with one or more of the other elements disclosed in FIG. 5, is a processing device, computing device or processor as such terms are used within this disclosure. When this disclosure uses the term “processor,” it may include a single processors, or multiple processors that distributed within a system or among multiple systems in a way such a together they perform all steps of a defined method. Read only memory (ROM) 710 and random access memory (RAM) 715 constitute examples of memory devices.

A controller 720 interfaces with one or more optional memory devices 725 that service as data storage facilities to the system bus 700. These memory devices 725 may include, for example, an external DVD drive or CD ROM drive, a hard drive, flash memory, a USB drive or another type of device that serves as a data storage facility. As indicated previously, these various drives and controllers are optional devices. Additionally, the memory devices 725 may be configured to include individual files for storing any software modules or instructions, auxiliary data, incident data, common files for storing groups of contingency tables and/or regression models, or one or more databases for storing the information as discussed above.

Program instructions, software or interactive modules for performing any of the functional steps associated with the processes as described above may be stored in the ROM 710 and/or the RAM 715. Optionally, the program instructions may be stored on a tangible computer readable medium such as a compact disk, a digital disk, flash memory, a memory card, a USB drive, an optical disc storage medium, a distributed computer storage platform such as a cloud-based architecture, and/or other recording medium.

A display interface 730 may permit information from the bus 700 to be displayed on the display 735 in audio, visual, graphic or alphanumeric format. Communication with external devices may occur using various communication ports 740. A communication port 740 may be attached to a communications network, such as the Internet, a local area network or a cellular telephone data network.

The hardware may also include an interface 745 which allows for receipt of data from input devices such as a keyboard 750 or other input device 755 such as a remote control, a pointing device, a video input device and/or an audio input device.

The above-disclosed features and functions, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

1. A system for analyzing transportation service performance, comprising:
a data storage facility containing historic values for a plurality of performance parameters of a plurality of transportation service route components;
a processor; and
a computer-readable medium containing programming instructions that, when executed, cause the processor to:
receive a selection of a route component, a time scale, and a parameter of interest,
identify a trending change in the parameter of interest during the time scale,
retrieve, from the data storage facility, values for a plurality of additional performance parameters that correspond to the selected route component and the selected time scale,
analyze the retrieved values for the plurality of additional performance parameters to identify trending changes in each of the additional performance parameters,
based on the identified trending changes in the additional performance parameters, determine which of the additional performance parameters influenced the trending change of the parameter of interest, and
output an identification of, and a graphic depiction of values during the time scale for, one or more of the additional performance parameters that influenced the trending change of the parameter of interest.

2. The system of claim 1, wherein:
the instructions that cause the processor to identify a trending change in the parameter of interest comprise instructions to identify a behavioral pattern; and
when determining which of the additional performance parameters influenced the trending change of the parameter of interest, only considering those additional performance parameters whose trending changes exhibit the behavioral pattern.

3. The system of claim 2, wherein the behavioral pattern comprises one or more of the following: linear behavior, non-linear behavior, or oscillating behavior.

4. The system of claim 1, further comprising additional programming instructions that, when executed, cause the processor to:
receive a selection of a sampling frequency; and
when retrieving the values for the plurality of additional performance parameters from the data storage facility, yielding a set of values that correspond to the sampling frequency.

5. The system of claim 1, wherein the instructions to analyze the retrieved values that correspond to the plurality of additional performance parameters to identify trending changes in each of the additional performance parameters comprise instructions to, for each of the additional performance parameters:
determine a plurality of magnitudes of the values of the additional performance parameter over the time scale;
for each determined magnitude, determine a coefficient;
for each coefficient, determine whether the coefficient has a positive or negative value; and
based on the determined positive or negative value, assign a behavioral pattern to the additional performance parameter over the time scale.

6. The system of claim 5, wherein the instructions to determine a coefficient for each determined magnitude comprise instructions to use one or more of the following algorithms to estimate the coefficient: Levenberg-Marquardt, Steepest Descent, Conjugate Gradient, Genetic Algorithms, or Nelder-Mead.

7. The system of claim 1, wherein the instructions further comprise instructions to:
receive a break point; and
when analyzing the trending changes for each of the additional performance parameters, determine whether there is a change in a behavioral pattern of the trending change within a threshold distance from the break point.

8. The system of claim 7, wherein the instructions to determine which of the additional performance parameters influenced the trending change of the parameter of interest comprise instructions to identify additional parameters that exhibit the same change in the behavioral pattern within the threshold distance from the break point.

9. A method for analyzing transportation service performance, comprising, by a processor:
receiving a selection of a route component, a time scale, and a parameter of interest;
identifying a trending change in the parameter of interest during the time scale;
retrieving, from a data storage facility containing historic values for a plurality of performance parameters of a plurality of transportation service route components, values for a plurality of additional performance parameters that correspond to the selected route component and the selected time scale;
analyzing the retrieved values for the plurality of additional performance parameters to identify trending changes in each of the additional performance parameters;
based on the identified trending changes in the additional performance parameters, determining which of the additional performance parameters influenced the trending change of the parameter of interest; and
outputting a report comprising an identification of, and a graphic depiction of values during the time scale for, one or more of the additional performance parameters that influenced the trending change of the parameter of interest.

10. The method of claim 9, wherein:
identifying the trending change in the parameter of interest comprises identifying a behavioral pattern; and
when determining which of the additional performance parameters influenced the trending change of the parameter of interest, the method does not consider additional performance parameters whose trending changes do not exhibit the behavioral pattern.

11. The method of claim 10, wherein the behavioral pattern comprises one or more of the following: linear behavior, non-linear behavior, or oscillating behavior.

12. The method of claim 9, further comprising:
receiving a selection of a sampling frequency; and
when retrieving the values for the plurality of additional performance parameters from the data storage facility, yielding a set of values that correspond to the sampling frequency.

13. The method of claim 9, wherein analyzing the retrieved values that correspond to the plurality of additional performance parameters to identify trending changes in each of the additional performance parameters comprises, for each of the additional performance parameters:
determining a plurality of magnitudes of the values of the additional performance parameter over the time scale;
for each determined magnitude, determining a coefficient;
for each coefficient, determining whether the coefficient has a positive or negative value; and
based on the determined positive or negative value, assigning a behavioral pattern to the additional performance parameter over the time scale.

14. The method of claim 13, wherein determining the coefficient for each determined magnitude comprises using one or more of the following algorithms to estimate the coefficient: Levenberg-Marquardt, Steepest Descent, Conjugate Gradient, Genetic Algorithms, or Nelder-Mead.

15. The method of claim 9, further comprising:
receiving a break point; and
when analyzing the trending changes for each of the additional performance parameters, determining whether there is a change in a behavioral pattern of the trending change within a threshold distance from the break point.

16. The method of claim 15, wherein determining which of the additional performance parameters influenced the trending change of the parameter of interest comprises identifying additional parameters that exhibit the same change in the behavioral pattern within the threshold distance from the break point.

17. A system for analyzing transportation service performance, comprising:
a data storage facility containing historic values for a plurality of performance parameters of a plurality of transportation service route components;
a processor; and
a computer-readable medium containing programming instructions that, when executed, cause the processor to:
receive a selection of a route component, a time scale, and a parameter of interest,
identify a change in behavioral pattern of the parameter of interest during the time scale, wherein the change in behavioral pattern comprises a change from one of the following behavioral patterns to another of the following behavioral patterns: linear behavior, non-linear behavior, oscillating behavior, or non-oscillating behavior,
retrieve, from the data storage facility, values for a plurality of additional performance parameters that correspond to the selected route component and the selected time scale,
analyze the retrieved values for the plurality of additional performance parameters to identify any changes in behavioral patterns of each of the additional performance parameters,
based on the identified changes in behavioral patterns of the additional performance parameters, determine which of the additional performance parameters influenced the trending change of the parameter of interest by identifying those additional performance parameters whose behavioral pattern changes corresponded to the change in behavioral pattern of the parameter of interest, and
output an identification of one or more of the additional performance parameters that influenced the change in behavioral pattern of the parameter of interest.

18. The system of claim 17, further comprising additional programming instructions that, when executed, cause the processor to:
receive a selection of a sampling frequency; and
when retrieving the values for the plurality of additional performance parameters from the data storage facility, yield a set of values that correspond to the sampling frequency.

19. The system of claim 17, wherein the instructions to analyze the retrieved values that correspond to the plurality of additional performance parameters to identify changes in behavioral patterns of each of the additional performance parameters comprise instructions to, for each of the additional performance parameters:
determine a plurality of magnitudes of the values of the additional performance parameter over the time scale;
for each determined magnitude, determine a coefficient;
for each coefficient, determine whether the coefficient has a positive or negative value; and
based on the determined positive or negative value, assign a behavioral pattern to the additional performance parameter over the time scale.

20. The system of claim 17, wherein the instructions further comprise instructions to:
receive a break point;
when identifying the change on the behavioral pattern of the parameter of interest, determine whether there is a change in a behavioral pattern of the parameter of interest within a threshold distance from the break point; and
when determining which of the additional performance parameters influenced the change in behavioral pattern of the parameter of interest, identify additional parameters that exhibit a corresponding change in behavioral pattern within the threshold distance from the break point.
